(19) United States
(12) Patent Application Publication
(10) Pub. No.: US 2024/0221044 A1
(43) Pub. Date: Jul. 4, 2024

(54) SYSTEMS AND METHODS OF USING AUGMENTED REALITY FOR GENERATING CUSTOM-DESIGNED WEARABLE ORNAMENTAL ARTICLES

(71) Applicant: EllansaLabs Inc., Addison, TX (US)

(72) Inventor: Omar Besim HAKIM, Addison, TX (US)

(73) Assignee: EllansaLabs Inc., Addison, TX (US)

(21) Appl. No.: 17/922,330

(22) PCT Filed: Oct. 27, 2022
(86) PCT No.: PCT/US2022/048070

§ 371 Date: Oct. 28, 2022

Related U.S. Application Data
(60) Provisional application No. 63/273,042, filed on Oct. 28, 2021.

(51) Int. Cl. G06Q 30/0601; G06Q 30/0283; G06Q 50/04; G06T 19/00; G06T 19/20

(52) U.S. Cl. CPC G06Q 30/0621; G06Q 30/0283; G06Q 30/0643; G06Q 50/04; G06T 19/006; G06T 19/20; G06T 2200/24; G06T 2219/2004; G06T 2219/2021; G06T 2219/2024

(57) ABSTRACT

In one embodiment, a method is disclosed for using augmented reality for generating custom-designed wearable ornamental articles. The method includes receiving a set of customer inputs indicating design parameters for a wearable ornamental article, generating, based on the design parameters, a three-dimensional model of the wearable ornamental article, displaying an augmented reality view of the three-dimensional model positioned on the customer's body, and manufacturing the wearable ornamental article based on the three-dimensional model.

### CROSS-REFERENCE TO OTHER APPLICATIONS

The present application claims the benefit of U.S. Provisional Application No. 63/273,042, titled “SYSTEMS AND METHODS OF USING AUGMENTED REALITY FOR GENERATING CUSTOM-DESIGNED WEARABLE ORNAMENTAL ARTICLES,” filed Oct. 28, 2021, the content of which is incorporated herein by reference in its entirety for all purposes.

### TECHNICAL FIELD

This disclosure relates to custom-designed articles. More specifically, this disclosure relates to systems and methods of using augmented reality for generating custom-designed wearable ornamental articles.

### BACKGROUND

Many articles (e.g., goods) offered for sale are held in an inventory at a physical location (e.g., storefront, warehouse, etc.) associated with an entity selling the articles. The articles may remain idle in the physical location as a result of a lack of an online presence marketing the articles and/or an ability to sell the articles online. Further, the articles may be typically already manufactured, and unless the articles are exactly what a customer is looking for, a customer may refrain from purchasing the articles. Instead, the customer may request the articles be modified, which may be costly, inefficient, and time consuming. In some instances, entities may provide websites where a customer may make design decisions pertaining to the articles: however, these websites leave much to be desired in terms of technical functionality.

### SUMMARY

In one embodiment, a method is disclosed for using augmented reality for generating custom-designed wearable ornamental articles. The method includes receiving a set of customer inputs indicating design parameters for a wearable ornamental article, generating, based on the design parameters, a three-dimensional model of the wearable ornamental article, displaying an augmented reality view of the three-dimensional model positioned on the customer's body, and manufacturing the wearable ornamental article based on the three-dimensional model.

In one embodiment, a system is disclosed for using augmented reality for generating custom-designed wearable ornamental articles. The system includes a user interface, a display, and a processing device. The processing device is configured to receive, with the user interface, a set of customer inputs indicating design parameters for a wearable ornamental article, generate, based on the design parameters, a three-dimensional model of the wearable ornamental article display, on the display, an augmented reality view of the three-dimensional model positioned on the customer's body, and manufacture the wearable ornamental article based on the three-dimensional model.

In one embodiment, a non-transitory computer-readable medium stores instructions. When executed, the instructions cause a processing device to receive a set of customer inputs indicating design parameters for a wearable ornamental article, generate, based on the design parameters, a three-dimensional model of the wearable ornamental article, display an augmented reality view of the three-dimensional model positioned on the customer's body, and manufacture the wearable ornamental article based on the three-dimensional model.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates a system architecture according to certain embodiments of this disclosure:

FIG. 2A illustrates a user interface including an augmented reality representation of a custom-designed wearable superimposed on a body part of a customer according to certain embodiments of this disclosure:

FIG. 2B illustrates a user interface including a virtual showcase and augmented reality representations of custom-designed wearables superimposed on a body part of a customer according to certain embodiments of this disclosure:

FIG. 3 illustrates a user interface including a warning indicating a three-dimensional model is too similar to a predetermine model for a wearable ornamental article according to certain embodiments of this disclosure:

FIG. 4 illustrates an example of a method for generating a three-dimensional model of a wearable ornamental article and displaying an augmented reality view of the model positioned on a customer's body according to certain embodiments of this disclosure:

FIG. 5 illustrates an example of a method for displaying an augmented reality view of a three-dimensional model positioned on a customer's body according to certain embodiments of this disclosure:

FIG. 6 illustrates an example of a method for determining and displaying a price for a wearable ornamental article according to certain embodiments of this disclosure: and

FIG. 7 illustrates an example computer system according to embodiments of this disclosure.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections: however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

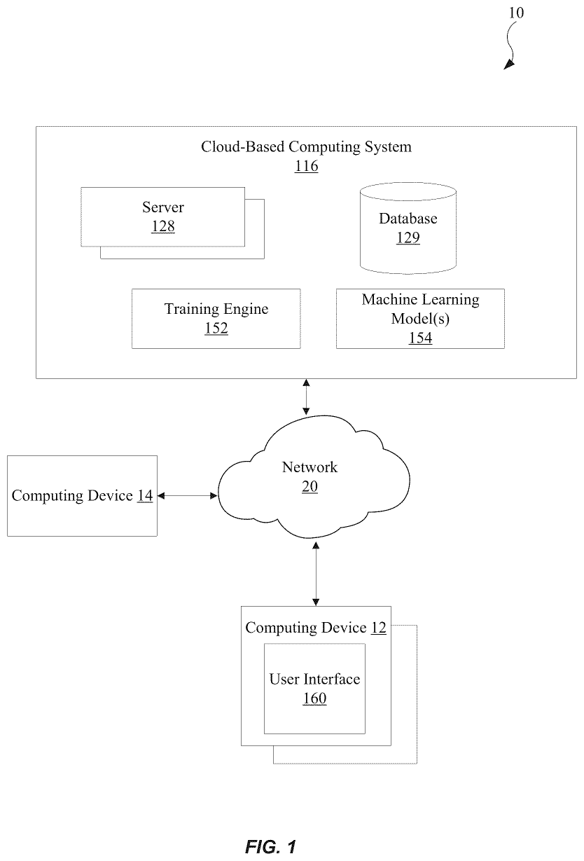

FIGS. 1 through 7, discussed below, and the various embodiments used to describe the principles of this disclosure in this patent document are by way of illustration only and should not be construed in any way to limit the scope of the disclosure.

Articles may refer to a good (e.g., jewelry, furniture, apparel, toy, computing device, vehicle, book, food, beverage, etc., item, wearable (e.g., watch), art, tattoo, piercing, etc. Throughout the following description, jewelry is referred to as the article for explanatory purposes, but it should be noted that any suitable article is contemplated to be within the scope of the present disclosure.

Oftentimes, jewelry stores maintain an inventory of jewelry that are stored in a warehouse or in their various brick-and-mortar stores (e.g., at stand-alone buildings, at shopping malls, etc.). Due to a lack of effective marketing and/or an online presence that provides e-commerce transactions, the inventories of jewelry may sit on shelves for an undesirable period of time without moving. In some instances, the jewelry in the stores' inventories may be over one year old and studies indicate that a piece of jewelry eighteen months old has an eighty percent chance of still being in inventory five years later.

Further, research indicates direct-to-customer fine jewelry sales are projected to grow in the future. Also, customers often prefer to make modifications and customizations to jewelry and such customizations to already manufactured jewelry is costly in terms of money and time. With the emergence of online dating applications, many customers may be comfortable customizing and ordering jewelry (e.g., custom engagement rings) online because they are comfortable finding significant others online. Also, customized jewelry is associated with a higher closing rate than prefabbed jewelry that is not customized.

In addition, conventional approaches to jewelry sales using large inventories of manufactured jewelry is prone to monetary loss in certain scenarios. For example, if a virus outbreak causes a global pandemic that forces brick-and-mortar stores to close due to social distancing and safety measures, customers may be prevented from entering physical stores to view and/or try on the jewelry in the inventories. Thus, the inventories may be largely stagnant. Websites offered by the jewelry stores lack the functionality to virtually try on virtual representations of the jewelry they are offering, which prevents customers from determining whether the jewelry fits and/or is aesthetically pleasing on their body.

Further, websites that may provide options for designing portions of jewelry do not provide real-time pricing of the jewelry. Also, the websites do not provide safeguards against in designing jewelry having certain physical restrictions (e.g., due to physical requirements) or legal restrictions (e.g., copyright). Thus, a technical problem exists pertaining to enabling customers to custom-design jewelry that complies with various restrictions via a software platform, to view and try on the custom-designed jewelry via a software platform, to view and try on an inventory of jewelry via a software platform, to determine a real-time price of custom-designed jewelry via a software platform, to order the custom-designed jewelry via a software platform, and/or to receive the manufactured custom-designed jewelry.

Accordingly, the present disclosure describes one or more embodiments that may provide one or more technical solutions to the above-described technical problems. For example, the present disclosure relates to systems and methods of using augmented reality for generating custom-designed wearable ornamental articles (e.g., jewelry). In some embodiments, a software platform may be executed by a cloud-based computing system. The cloud-based computing system may include one or more servers that are connected in a distributed network and that execute the software platform. The cloud-based computing system (e.g., executing the software platform) may receive a set of customer inputs indicating design parameters for a wearable ornamental article. In some embodiments, the set of customer inputs may include audio, video, images, hand-written notes, and the like.

In some embodiments, the software platform may include an application executing on a computing device of a customer, a personal jeweler, a sales person, or any suitable user. The application may be a stand-alone computer application (e.g., installed on an operating system of the computing device) or may be executing within another computer application (e.g., a website within a web browser installed on the operating system of the computing device). The application may provide numerous user interfaces on a display of the computing device.

The set of customer inputs may be received from a computing device of a customer, a sales person associated with an entity selling the custom-designed wearable ornamental articles, or any suitable user. For example, the computing device may include a camera (e.g., capable of light detection and ranging (LIDAR) scanning, capturing images, etc.), a microphone, a touchscreen, a processing device, a memory device, a network interface, and the like. The computing device may capture the set of customer inputs and transmit them to the cloud-based computing system. The customer may enter the set of inputs via a website or application associated with an entity selling the custom-designed wearable ornamental articles, and/or the customer may provide the inputs to a sales person who enters the inputs via the sales person's computing device.

The cloud-based computing system may generate, based on the design parameters, a three-dimensional model of the wearable ornamental article. In some embodiments, the three-dimensional model may be a computer-aided design (CAD) model stored as a file type that enables manipulation and animation via augmented reality techniques. In some embodiments, a computing device of a personal jeweler may generate the three-dimensional model of the wearable ornamental article.

The cloud-based computing system may display, in a user interface of a computing device, an augmented reality view of the three-dimensional model positioned on the customer's body. For example, the computing device may include a camera that is pointed toward a part of the customer's body with which the wearable ornamental article is associated. The real part of the customer's body may be presented in a user interface of the computing device as live streaming video and the three-dimensional model may be overlaid (superimposed) on at least a portion of the part of the customers' body. The customer's body may include their hand or hands, neck, foot or feet, ankle, waist, head, leg or legs, arm or arms, chest, back, thigh or thighs, calf or calves, forearm or forearms, bicep or biceps, tricep or triceps, gluteus, face, writ or wrists, etc.

The augmented reality view may superimpose the three-dimensional model of the wearable ornamental article such that it is positioned proportionally and dimensionally accurate with respect to the customer's body part. For example, the wearable ornamental article may be a ring, and the three-dimensional model of the ring may be displayed in the augmented reality view as being worn by a ring finger of the customer's hand and may be positioned on a particular phalange between knuckles and surrounding phalanges. As the user rotates their hand in view of a camera of the computing device, the hand and the three-dimensional model may be rotated accurately in the augmented reality view presented on a computing device of the customer and/or any suitable user.

The cloud-based computing system may manufacture the wearable ornamental article based on the three-dimensional model. In some embodiments, the three-dimensional model is transmitted to a manufacturing machine (e.g., tool) configured to implement and execute computer numerical control (CNC). The manufacturing machine may be a three-dimensional printer, a drill, a grinder, a molder, etc. and the manufacturing machine may perform additive and/or reductive techniques. For example, the digital file representing the three-dimensional model may be received by a processing device of the manufacturing machine and the processing device may use the digital file to perform the CNC of the manufacturing machine. In some embodiments, the manufacturing machine may create a three-dimensional wax cast of the wearable ornamental article, and the three-dimensional wax cast may be used to pour desired metal (e.g., silver, gold, platinum, etc.) and form at least a portion of the wearable ornamental article. In some embodiments, the manufacturing machine may manufacture the wearable ornamental article by three-dimensionally printing the wax cast, pouring the metal to form a setting, placing a stone (e.g.,) in the setting, etching a portion of the wearable ornamental article, or some combination thereof.

The cloud-based computing system may execute an artificial intelligence engine that uses a training engine to generate one or more machine learning models. The machine learning models may be trained to perform any of the operations of the methods described herein. In some embodiments, the machine learning models may be trained to generate a three-dimensional model of a wearable ornamental article based on various inputs. In some embodiments, the machine learning models may be trained to display an augmented reality view of the three-dimensional model positioned on the customer's body part. In some embodiments, the machine learning models may be trained to determine a price for the wearable ornamental article. In some embodiments, the machine learning models may be trained to determine whether a customized wearable ornamental article complies the certain laws, regulations, restrictions, and the like. For example, the machine learning models may be trained with a corpus of training data including designs of articles that are protected by copyrights and may perform similarity analysis to determine an amount (e.g., percentage, value, etc.) of similarity between the customized wearable ornamental article and the copyrighted article. The machine learning models may be trained to generate a warning and/or notification including the amount of similarity and provide suggested design changes to make to the customized wearable article to comply with the laws, regulations, restrictions, and the like.

In some embodiments, the machine learning models may be continuously retrained and/or modified to enhance feature selection of the machine learning models. For example, as updated training data is received and/or user input is provided (e.g., approving or rejecting an output by a machine learning model), the machine learning models may dynamically and automatically change one or more features, such as a number of hidden layers, an activation function, a number of nodes in a layer, a weight applied to an objective function executed by one of the nodes, and the like. The feature selection may be modified to optimize the output of the trained machine learning models.

In some embodiments, the disclosed embodiments may provide various technical benefits. For example, the software platform may enable virtually designing a wearable ornamental article in real-time based on various design parameters. Further, using augmented reality, the software platform may provide an enhanced user interface by enabling a user to virtually “try on” their custom-designed wearable ornamental article on a body part using a camera and a three-dimensional model. Further, some embodiments determine a price (e.g., including materials, labor, tariffs, shipping costs, insurance costs, etc.) in real-time as the wearable ornamental article is being designed. Such a technical solution provides a process for enabling a customer to design and determine whether the customized wearable ornamental article looks and/or fits properly in a digital augmented reality setting without the customer having to be in a physical store and/or have access to a manufactured physical article. As a result, materials, physical resources, and money are saved because the article is not manufactured until the customer is satisfied with it.

Further, in some embodiments, a virtual showcase is presented on a user interface of a computing device of the customer, a sales person, or any suitable user. The virtual showcase includes one or more virtual representations of wearable ornamental articles (e.g., that have been pre-designed). The user may select to virtually “try on” one or more of the virtual representations by placing their body part in a view of a camera of the computing device and an augmented reality view will superimpose the selected virtual representations on the body part in a user interface of the computing device. In some embodiments, more than one virtual representation of wearable ornamental articles may be concurrently presented on more than one image/video of the customer's body part to enable the customer to compare which wearable ornament article they prefer or like more. Such an enhanced user interface may improve the customer's experience using the computing device and provide a technical improvement. For example, the user may not have to scroll between different user interfaces to view different three-dimensional models superimposed on their body part. Accordingly, using a single user interface to concurrently present multiple three-dimensional models may reduce computing resources associated with generating and loading additional user interfaces.

Turning now to the figures. FIG. 1 depicts a system architecture 10 according to some embodiments. The system architecture 10 may include one or more computing devices 12 of one or more customers communicatively coupled to a cloud-based computing system 116 and/or one or more computing devices 14 of one or more sales people or third-party entities. Each of the computing devices 12 computing devices 14, and components included in the cloud-based computing system 116 may include one or more processing devices, memory devices, and/or network interface devices. The network interface devices may enable communication via a wireless protocol for transmitting data over short distances, such as Bluetooth, ZigBee, NFC, etc. Additionally, the network interface devices may enable communicating data over long distances, and in one example, the computing devices 12, the computing device 14, and the cloud-based computing system 116 may communicate with a network 20. Network 20 may be a public network (e.g., connected to the Internet via wired (Ethernet) or wireless (WiFi)), a private network (e.g., a local area network (LAN) or wide area network (WAN)), or a combination thereof. Network 20 may also comprise a node or nodes on the Internet of Things (IOT).

The computing devices 12 and/or 14 may be any suitable computing device, such as a laptop, tablet, smartphone, or computer. The computing devices 12 may include a display capable of presenting a user interface 160 of an application. The application may be implemented in computer instructions stored on the one or more memory devices of the computing devices 12 and executable by the one or more processing devices of the computing device 12. The application may present various screens to a user. For example, the user interface 160 may present an image or video of a body part of a customer and an augmented reality view of a three-dimensional model associated with a wearable ornamental article superimposed on the body part. The user interface may also present a virtual showcase of one or more three-dimensional models of wearable ornamental articles. The one or three-dimensional models may be superimposed concurrently on more than one image of the customer's body part. Further, the user interface may provide various graphical elements that enable the customer to modify design parameters of a wearable ornamental design in real-time and/or near real-time. In addition, the user interface may present a determined price of a custom-designed wearable ornamental article.

In some embodiments, the application is a stand-alone application installed and executing on the computing devices 12 and 14. In some embodiments, the application (e.g., website) executes within another application (e.g., web browser). The computing devices 12 and 14 may also include instructions stored on the one or more memory devices that, when executed by the one or more processing devices of the computing devices 12 and 14 perform operations of any of the methods described herein.

In some embodiments, the computing devices 12 and/or 14 may receive customer inputs related to design parameters of a wearable ornamental article. The computing devices 12 and/or 14, and/or the cloud-based computing system 116 may receive the customer inputs and generate a three-dimensional model of the wearable ornamental design based on the design parameters. For example, in some embodiments, a personal jeweler may use the computing device 14 to generate the three-dimensional model, and/or in some embodiments, the cloud-based computing system 116, the computing device 12, and/or the computing device 14 may execute instructions that automatically generate the three-dimensional model based on the design parameters.

In some embodiments, the cloud-based computing system 116 may include one or more servers 128 that form a distributed computing architecture. The servers 128 may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 128 may include one or more processing devices, memory devices, data storage, and/or network interface cards. The servers 128 may be in communication with one another via any suitable communication protocol. The servers 128 may execute an artificial intelligence (AI) engine that uses one or more machine learning models 154 to perform at least one of the embodiments disclosed herein. The cloud-based computing system 128 may also include a database 129 that stores data, knowledge, and data structures used to perform various embodiments. For example, the database 129 may store predetermined models of wearable ornamental articles subject to one or more laws, regulations, and/or restrictions. The database 129 may store generated three-dimensional models associated with wearable ornamental articles, designs of the wearable ornamental articles, customer profiles, prices associated with the wearable ornamental articles, costs of various factors (e.g., materials, manufacturing, settings, metals, tariffs, shipping, labor, commissions, markups, etc.). In some embodiments, the database 129 may be hosted on one or more of the servers 128.

In some embodiments the cloud-based computing system 116 may include a training engine 152 capable of generating the one or more machine learning models 154. The machine learning models 154 may be trained to generate a three-dimensional model of a wearable ornamental article based on various inputs (e.g., design parameters). In some embodiments, the machine learning models may be trained to display an augmented reality view of the three-dimensional model positioned on the customer's body part. In some embodiments, the machine learning models may be trained to determine a price for the wearable ornamental article. In some embodiments, the machine learning models may be trained to determine whether a customized wearable ornamental article complies with certain laws, regulations, restrictions, and the like. For example, the machine learning models may be trained with a corpus of training data including designs of articles that are protected by registered copyrights and may perform similarity analysis to determine an amount (e.g., percentage, value, etc.) of similarity between the customized wearable ornamental article and the copyrighted article. The machine learning models may be trained to generate a warning and/or notification including the amount of similarity and provide suggested design changes to cause the customized wearable article to comply with the laws, regulations, restrictions, and the like.

The one or more machine learning models 154 may be generated by the training engine 130 and may be implemented in computer instructions executable by one or more processing devices of the training engine 152 and/or the servers 128. To generate the one or more machine learning models 154, the training engine 152 may train the one or more machine learning models 154.

The training engine 152 may be a rackmount server, a router computer, a personal computer, a portable digital assistant, a smartphone, a laptop computer, a tablet computer, a netbook, a desktop computer, an Internet of Things (IOT) device, any other desired computing device, or any combination of the above. The training engine 152 may be cloud-based, be a real-time software platform, include privacy software or protocols, and/or include security software or protocols.

To generate the one or more machine learning models 154, the training engine 152 may train the one or more machine learning models 154. The training engine 152 may use a base data set of design parameters and labels corresponding to three-dimensional models associated with wearable ornamental articles.

The one or more machine learning models 154 may refer to model artifacts created by the training engine 152 using training data that includes training inputs and corresponding target outputs. The training engine 152 may find patterns in the training data wherein such patterns map the training input to the target output and generate the machine learning models 154 that capture these patterns. For example, the machine learning model may receive design parameters and determine a three-dimensional model to generate as output based on similar design parameters. The machine learning models 154 may receive the design parameters and other information (e.g., shipping, tariffs, labor, etc.) as input and match the input to a price to associated with the wearable ornamental article to manufacture according to the design parameters and other information. In some embodiments, the machine learning models 154 may be trained with input data related to image data of a body part of a customer and a three-dimensional model of a wearable ornamental article and mapped outputs of a superimposed augmented reality view of the three-dimensional model on a target location of the customer's body part. Although depicted separately from the server 128, in some embodiments, the training engine 152 may reside on server 128. Further, in some embodiments, the database 129, and/or the training engine 152 may reside on the computing devices 12 and/or 14.

As described in more detail below; the one or more machine learning models 154 may comprise, e.g., a single level of linear or non-linear operations (e.g., a support vector machine [SVM]) or the machine learning models 154 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons.

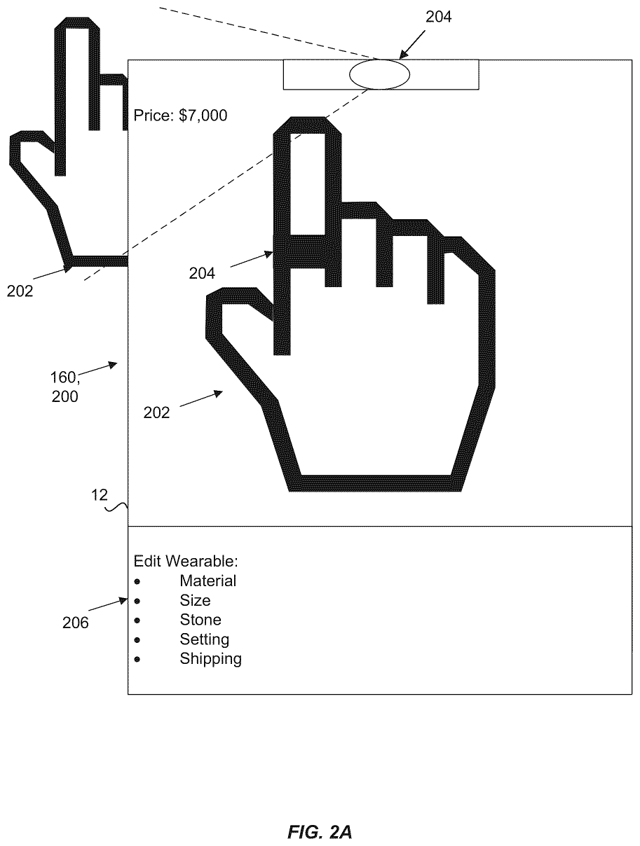

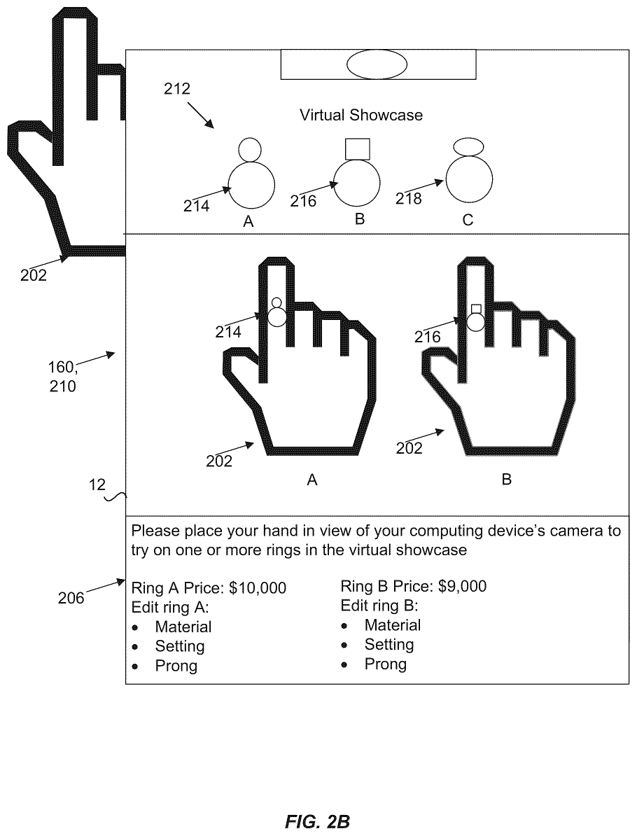

FIG. 2A illustrates a user interface 160, 200 including an augmented reality view of a custom-designed wearable ornamental article superimposed on a body part 202 (e.g., hand) of a customer according to certain embodiments of this disclosure. The computing device 12 includes a display presenting a user interface 160, 200. The user interface 160, 200 presents an image (and/or livestreaming video) of the actual body part 202 of the user. As depicted, a camera 204 of the computing device 12 is angled at the body part 202 of the customer's hand. The body part 202 is within the view of the camera 204 as depicted by dashed lines. As should be noted, the body part 202 does not include a wearable ornamental article (e.g., ring) on any phalanges in real life. That is, the customer is not wearing a ring on their hand in real life in the depicted FIG. 2.

The cloud-based computing system 116, computing device 12, and/or computing device 14 may receive customer inputs related to design parameters of a ring (any suitable wearable ornamental article). The cloud-based computing system 116, computing device 12, and/or computing device 14 may generate, based on the design parameters, a three-dimensional model of the wearable ornamental article. In some embodiments, a wireframe of the wearable ornamental article may be generated based on the design parameters. In some embodiments, LIDAR may be used to three-dimensionally scan a physical wearable ornamental article and to generate the three-dimensional model. In some embodiments, one or more machine learning models may be trained to generate the three-dimensional model based on the design parameters.

As depicted, an augmented reality view of the three-dimensional model 204 may be positioned on the customer's body part 202 in the user interface 160, 200. The three-dimensional model 204 (e.g., depicted as a black band on a phalange of the customer) may be a virtual representation of the wearable ornamental article and may include a photorealistic appearance of the custom-designed wearable ornamental article. Accordingly, the disclosed techniques enable providing the user interface 160, 200 that allows a customer to virtually try on a custom-designed wearable ornamental article in real-time and determine how the wearable ornamental article looks on their actual body parts.

Further, in some embodiments, a price of the custom-designed wearable ornamental article may be determined. The price may account for a cost of materials, a cost of manufacturing, a cost of tariffs, a cost of shipping, a cost of labor, a cost of a stone, and the like. In some embodiments, the customer may select a particular GIA certificate and the characteristics specified in the certificate enable determining the exact wholesale price for the selected stone. Further, the price may account for a commission that is specified in an agreement between the entity selling the wearable ornamental article and/or a third-party (e.g., personal jeweler). As depicted, the user interface 160, 200 depicts the prices of the custom-designed wearable ornamental article as $7,000.

Further, a portion 206 of the user interface 160, 200 may include various graphical elements in a menu that enables modifying the design parameters of the wearable ornamental article. As depicted, the graphical elements may be associated with materials, size, stone, setting, shipping, etc. Any suitable additional graphical elements may be included in the portion 206 of the user interface 160, 200. The three-dimensional model may be modified, in real-time or near real-time, in the augmented reality view on the customer's body part based on the customer making modifications using the graphical elements in the portion 206. Accordingly, the customer may be enabled to quickly modify various design parameters until they find the exact desired design for the wearable ornamental article. Further, the user interface 160, 200 may dynamically update the price as the design parameters are modified via the graphical elements in the portion 206. Accordingly, the disclosed techniques may enable a customer having a certain budget to adjust the design parameters as desired to generate a design of a wearable ornamental article within that price budget.

FIG. 2B illustrates a user interface 160, 210 including a virtual showcase 212 and augmented reality representations of custom-designed wearable ornamental articles superimposed on a body part 212 (e.g., hand) of a customer according to certain embodiments of this disclosure. The computing device 12 includes a display presenting a user interface 160, 200. The virtual showcase 212 may include one or more predetermined designs of wearable ornamental articles. Three-dimensional models 214, 216, and 218 associated with each of the wearable ornamental models A, B, and C may be presented in the virtual showcase 212.

As depicted, user interface 160, 210 presents an image (and/or livestreaming video) of the actual body part 202 of the user. The image of the body part 202 may include one or more of the three-dimensional models 214, 216, and/or 218 superimposed at a target location on the body part 202 in the image. For example, in some embodiments, if the customer uses an input peripheral to select a single wearable ornamental article in the virtual showcase 212, then just the three-dimensional model associated with that wearable ornamental article may be superimposed on at a location of the customer's body part in the user interface 160, 210. In some embodiments, and as depicted, the user interface 160, 210 may enable the user to compare how more than one wearable ornamental article looks on their body part. For example, the user may select the wearable ornamental article A and B in the virtual showcase 212, and the three-dimensional models 214 and 216 may be superimposed at a location on the body part 202 of the customer in the user interface 160, 210. Such techniques may provide an enhanced user interface that enables the customer to compare the wearable ornamental articles A and B on an image of their actual hand 202 to determine which one they prefer.

Further, the portion 206 of the user interface 160, 210 may provide instructions to the customer. The instructions indicate “Please place your hand in view of your computing device's camera to try on one or more rings in the virtual showcase.” In some embodiments, the portion 206 may provide the price of each wearable ornamental article. For example, Ring A is priced at $10,000 and Ring B is priced at $9,000. In some embodiments, the wearable ornamental articles displayed in the virtual showcase 212 may be custom-designed or predetermined designs. The portion 206 may provide graphical elements that enable modifying design parameters associated with the wearable ornamental article. When the design parameters are modified, the prices may be dynamically modified and presented in real-time or near real-time in the portion 206.

It should be noted, that in either user interface 160, 200 and/or 160, 210, the user may be presented with an option to purchase the wearable ornamental article. Upon selecting to purchase to the wearable ornamental article and completing payment, the three-dimensional model and/or design associated with the wearable ornamental article may be transmitted to a manufacturing machine to manufacture the wearable ornamental article. For example, the manufacturing machine may perform CNC operations to three-dimensionally print the wearable ornamental article.

In some embodiments, the cloud-based computing system 116 may be communicatively coupled to one or more digital payment applications (e.g., Venmo®, Google Pay®, Apple Pay®, etc.), one or more credit card applications (e.g., Visa®, Mastercard®, etc.), one or more third-party services, etc. that enable processing purchasing transactions (e.g., moving funds between bank accounts) such that a customer can buy the wearable ornamental article they desire.

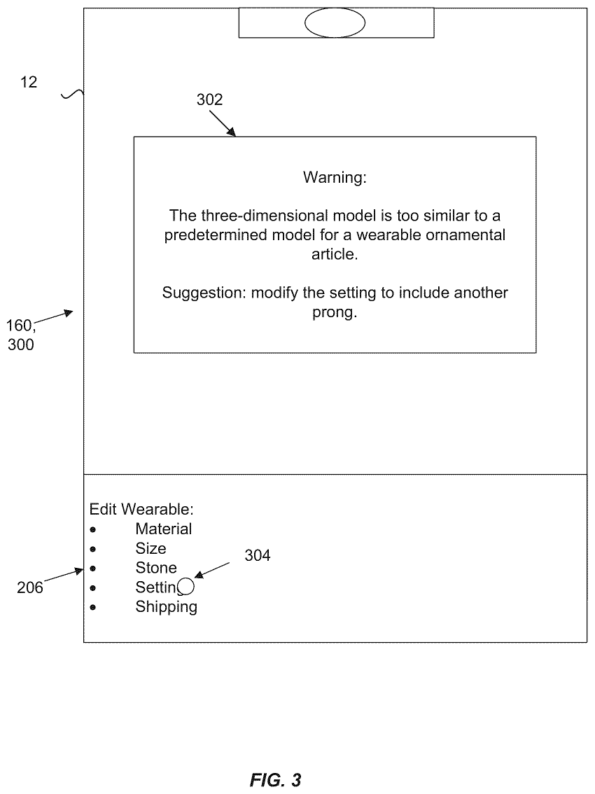

FIG. 3 illustrates a user interface 160, 300 including a warning 302 indicating a three-dimensional model is too similar to a predetermine model for a wearable ornamental article according to certain embodiments of this disclosure. The warning 302 may be a notification pushed from the cloud-based computing system 116, a message transmitted from the cloud-based computing system 116, etc. In some embodiments, the user interface 160, 300 may be presented on a display of the computing device 12 and/or the computing device 14.

As described further herein, predetermined models may be associated with one or more laws, regulations, and/or restrictions. For example, some predetermined models may be associated with designs that are registered copyrights under certain jurisdictions and a metric may be used to determine a level of similarity between the generated three-dimensional model and the predetermined model. If a predetermined threshold indicating that the two models are sufficiently different is not satisfied, then the warning 302 may be generated and presented on the user interface 160, 300. In some embodiments, the warning 302 may state, as depicted, “The three-dimensional model is too similar to a predetermined model for a wearable ornamental article.” If the warning 302 is displayed, then manufacturing of the wearable ornamental article may be disabled. The warning 302 may also include a suggestion to modify a design parameter to cause the design of the three-dimensional model to satisfy the predetermined threshold. The warning 302 states “Suggestion: modify the setting to include another prong.” When the predetermined threshold is satisfied, then the models may be sufficiently different and the wearable ornamental article may be manufactured.

As depicted, the user selected (e.g., represented by circle 304) to modify a setting in the portion 206. The setting may be modified in real-time and the three-dimensional model may be dynamically updated. If the setting causes the metric to be above the predetermined threshold, then the warning 302 may be removed from display on the user interface 160, 300 and manufacturing of the wearable ornamental article may be enabled.

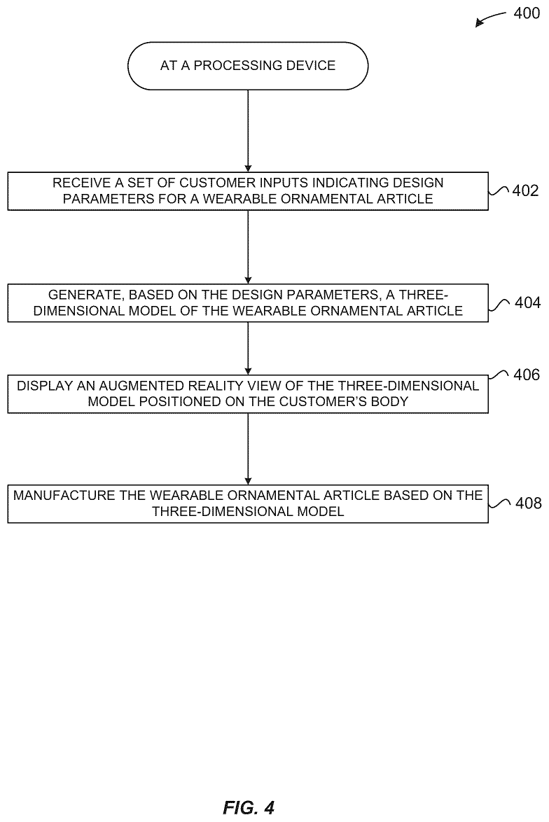

FIG. 4 illustrates an example of a method 400 for generating a three-dimensional model of a wearable ornamental article and displaying an augmented reality view of the model positioned on a customer's body according to certain embodiments of this disclosure. The method 400 may be performed by processing logic that may include hardware (circuitry, dedicated logic, etc.), software, or a combination of both. The method 400 and/or each of their individual functions, subroutines, or operations may be performed by one or more processors of a computing device (e.g., any component (server 128, training engine 152, machine learning models 154, etc.) of cloud-based computing system 116, computing device 14, and/or computing device 12 of FIG. 1) implementing the method 400. The method 400 may be implemented as computer instructions stored on a memory device and executable by the one or more processors. In certain implementations, the method 400 may be performed by a single processing thread. Alternatively, the method 400 may be performed by two or more processing threads, each thread implementing one or more individual functions, routines, subroutines, or operations of the methods.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 402, the processing device may receive a set of customer inputs indicating design parameters for a wearable ornamental article. The wearable ornamental article may include jewelry (e.g., necklace, ring, anklet, earring, bracelet, etc.), a tattoo, a piercing, and/or any other suitable article that is wearable or integrated with a part of the body of the customer. The set of customer inputs may include image data (e.g., video, still image, image frames, etc.), audio data, and/or hand-written notes. The design parameters may include a type of stone, a characteristic (e.g., cut, clarity, carat, color) of a stone, a Gemological Institute of America certificate for a particular stone, a material (e.g., precious metal such as silver, gold, white gold, platinum, etc.), a setting type, a setting style, a size of a band, a number of prongs for a setting, and/or any suitable design parameter related to a wearable ornamental article.

The image data may be obtained via a camera included in the computing device 12 of the user and/or the computing device 14 of the sales person. The camera may be capable of performing light detection and ranging (LIDAR) techniques to three-dimensionally scan objects and/or environments. For example, the camera may use laser beams to scan the object and generate a three-dimensional image representing the object (e.g., a piece of jewelry, etc.). The camera may include a LIDAR sensor that emits pulse wave forms into the environment and determine an amount of time it takes for the wave forms to return to the sensor. Based on the amount of time, the processing device of the computing is capable of generating a three-dimensional scanned image of the object being scanned.

The audio data may include spoken words from the consumer (e.g., pertaining to design parameters of the wearable ornament article), recorded voice, or the like, and may be received by a microphone of the computing device.

The hand-written notes may be obtained by the camera taking an image. Natural language processing, optical character recognition, and the like may be used to process the image including the hand-written notes to obtain the design parameters. Other input peripherals, such as touchscreens, keyboards, and/or mice may be used to enter customer input. The input peripherals may be used to select and/or actuate graphical elements on a user interface, where the graphical elements relate to design parameters associated with the customer input. For example, the graphical elements may include sliders, text boxes, radio buttons, etc. that are modifiable to change the cut, color, clarity, and/or carat of a stone, to change a type of material to use for a setting, a number of prongs to include in the setting, and so forth.

In some embodiments, the customer inputs may include a portion of a physical magazine (e.g., an image of a ring in a magazine on a page torn out by the customer and brought into a physical jewelry store) or newspaper. The customer input may include a image file obtained from a website and/or an application associated with a jewelry store or any suitable entity that depicts wearable ornamental articles on their website and/or application. For example, the image file may be a screenshot of a piece of jewelry a celebrity is wearing in a social media post on a social media platform. In another example, the customer input may be a link to a certain website (e.g., Pinterest®) that includes a written description and/or an image of a wearable ornamental article and the disclosed embodiments may access the link and perform screen scraping techniques (e.g., object character recognition, optical character recognition, natural language processing, image detection and capture, etc.) to obtain the design parameters from the website.

At block 404, the processing device may generate, based on the design parameters, a three-dimensional model of the wearable ornamental article. In some embodiments, a personal jeweler may receive the design parameters and generate, using the computing device 14, a Computer Aided Design (CAD) image including a three-dimensional model. In some embodiments, the processing device may automatically generate the three-dimensional model based on the design parameters. In some embodiments, the one or machine learning models may be trained using a corpus of training data including inputs related to design parameters and outputs related to three-dimensional models. The one or more machine learning models may receive a subsequent set of design parameters and map them to a certain three-dimensional model that is generated and output. In some embodiments, the design parameters may be associated with a set of geometries (e.g., radiuses, widths, heights, sizes, shapes, etc.) and values that are used to proportionally and accurately generate a photo-realistic three-dimensional model of a wearable ornamental article. In some embodiments, a lookup table may be used to identify the geometries and values based on the received design parameters.

In some embodiments, based on the three-dimensional model generated according to the design parameters, a set of rules, restrictions (e.g., physical, material, cost), laws, and/or regulations may referenced and/or applied to generate alterative three-dimensional models having alternative designs. For example, there may be a finite set of alternative designs that are allowed based on the rules, restrictions, laws, and/or regulations. In one instance, the amount of material available may be limited, and thus, the size of the wearable ornamental article may not be modified. In another instance, a setting may be modified to add another prong but if two prongs are added, a physical restriction of spacing between prongs may be violated, and thus, the addition of two prongs may be denied. The processing device may generate a maximum number of alternative three-dimensional models for the wearable ornamental design based on the set of rules, restrictions, laws, and/or regulations. That is the rules, restrictions, laws, and/or regulations may operate as constraints in a function that is solved to produce each feasible alternative within the constraints. The alternative three-dimensional models and/or designs may be stored in the database 129. In some embodiments, the processing device may submit and/or initiate submitting the alternative three-dimensional models and/or designs to be registered for copyrights with a third-party system (e.g., United States Patent Copyright Office).

In some embodiments, the processing device may compare the three-dimensional model to a predetermined model of a wearable ornamental article. In some embodiments, the processing device may be communicatively coupled to one or more external sources (e.g., databases, application programming interfaces (APIs), etc.) and may obtain a plurality of predetermined models of wearable ornamental articles from the one or more external sources. For example, various design patent applications and/or issued design patents may be obtained from a database and/or API associated with the United States Patent and Trademark Office. Further, one or more predetermined models and/or designs associated with the predetermined models that are protected by a registered copyright may be obtained from a database and/or API associated with the United States Copyright Office.

In some embodiments, the predetermined model of the wearable ornamental article may represent a particular design that may be subject to one or more laws, regulations, and/or restrictions. For example, the design of the predetermined model may be copyrighted and/or trademarked via one or more laws of a particular jurisdiction. The processing device may determine a metric indicating a design differential between the three-dimensional model and the predetermined model. The metric may be associated with a degree of similarity between one or more design parameters of the three-dimensional model and the predetermined model. The processing device may determine that the metric is below a predetermined threshold. If the metric is below the predetermined threshold, then the design represented by the three-dimensional model may be too similar to the design represented by the predetermined model.

Responsive to determining that the metric is below the predetermined threshold, the processing device may generate a warning signal and/or transmit a notification to a computing device associated with the customer, the sales person, and/or any suitable user. Such techniques may enable preventing a customer and/or the entity selling/manufacturing the wearable ornamental article from infringing on a particular law (e.g., copyright), regulation, restriction, etc. associated with a predetermined model. In some embodiments, the restriction may relate to a physical dimension or material requirement of a particular wearable ornamental article. The notification may provide suggested modifications to the design of the three-dimensional model, and the modifications may cause the metric to exceed the predetermined threshold. If the metric exceeds the predetermined threshold, then the processing device may provide a notification indicating the same and the wearable ornamental article may be manufactured.

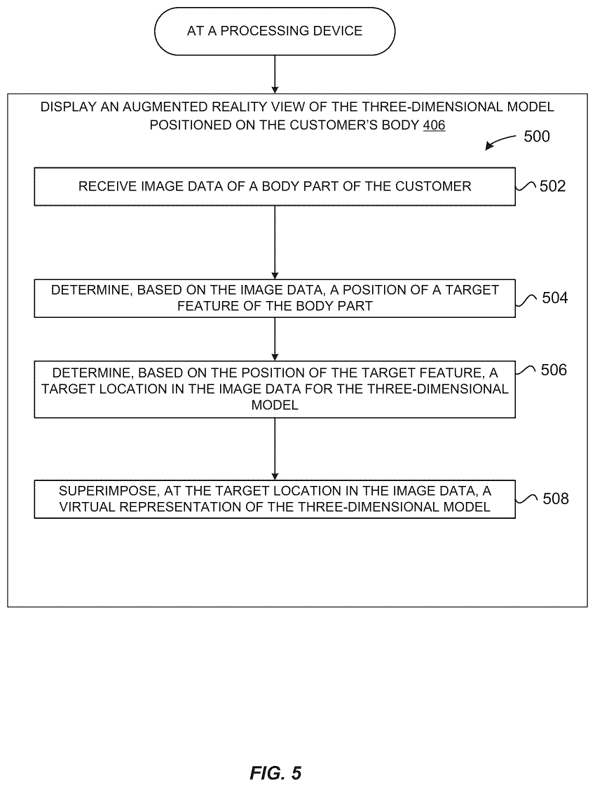

At block 406, the processing device may display an augmented reality view of the three-dimensional model positioned on the customer's body. Additional details related to displaying the augmented reality view of the three-dimensional model positioned on the customer's body are discussed with reference to the method 500 of FIG. 5.

In some embodiments, the processing device may receive an updated customer input indicating a design change for the wearable ornamental article. The processing device may generate, based on the design change, an updated three-dimensional model of the wearable ornamental article. The processing device may display an updated augmented reality view of the updated three-dimensional model positioned on the customer's body. In some embodiments, each and every change made to the design of the wearable ornamental article may be stored in a database (e.g., at the cloud-based computing system 116, computing device 12, and/or computing device 14). The tracked changes stored in the database may provide an audit trail that enables an interested party to analyze the changes (e.g., timestamped and detailed with what design parameters were changed) to review and/or verify the changes were made.

At block 408, the processing device may manufacture the wearable ornamental article based on the three-dimensional model. For example, one or more control instructions, files including the three-dimensional model, or the like may be transmitted to a processing device associated with a manufacturing machine. In some embodiments, the manufacturing machine may include a three-dimensional printer. The processing device of the manufacturing machine may receive the file and/or control instructions and perform one or more operations related to CNC (e.g., additive and/or reductive techniques) to manufacture at least a portion of the wearable ornamental article.

FIG. 5 illustrates an example of a method 500 for displaying an augmented reality view of a three-dimensional model positioned on a customer's body according to certain embodiments of this disclosure. The method 500 may be performed by processing logic that may include hardware (circuitry, dedicated logic, etc.), software, or a combination of both. The method 500 and/or each of their individual functions, subroutines, or operations may be performed by one or more processors of a computing device (e.g., any component (server 128, training engine 152, machine learning models 154, etc.) of cloud-based computing system 116, computing device 14, and/or computing device 12 of FIG. 1) implementing the method 500. The method 500 may be implemented as computer instructions stored on a memory device and executable by the one or more processors. In certain implementations, the method 500 may be performed by a single processing thread. Alternatively, the method 500 may be performed by two or more processing threads, each thread implementing one or more individual functions, routines, subroutines, or operations of the methods.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

The method 500 may include one or more steps or operations that are performed as part of block 406 (e.g., displaying an augmented reality view of the three-dimensional model positioned on the customer's body) of the method 400 in FIG. 4.

At block 502, the processing device may receive image data of a body part of the customer. The image data may be obtained via a camera of the computing device 12 and/or the computing device 14. In some embodiments, the body part may include a hand, a foot, a neck, a face, a head, a leg, an arm, a torso, or any suitable body part of the customer. The camera may generate an image file representing the body part. In some embodiments, the image data may be obtained from a database and/or social media platform (e.g., of a social media platform where the user has an account and has stored images of their self in database associated with the social media platform and/or has generated social media posts including images of their self).

At block 504, the processing device may determine, based on the image data, a position of a target feature on the body part. The processing device may scan the image data of the body part and map an outline, boundary, geometry, features (e.g., size, width, shape, color, etc.), etc. of the body part. In some embodiments, a software development kit (SDK) may be used to map a surface of the body part. The mapped body part may enable identifying various features of the body part. For example, based on the dimensions (e.g., length and/or width) of a particular mapped object in the image data, the processing device may determine (e.g., via a trained machine learning model) that the mapped object is a phalange of a hand. For example, the SDK may identify the phalanges of a hand, knuckles of the hand, palm of the hand, back of the hand, etc. A target feature may include a phalange identified in the image data, a knuckle, a foot, a toe, an ankle, a neck, an ear lobe, a nostril, a nose, an eyebrow, a wrist, or any suitable part of the customer's body.

At block 506, the processing device may determine, based on the position of the target feature, a target location in the image data for the three-dimensional model. The target feature may be located at a particular position within the image data. The position may be associated with coordinates of pixels in the image data. If the three-dimensional model represents a ring and the target feature is a ring finger, then a target location in the image data may be determined to be a portion of the ring finger proximately located relative to a knuckle associated with the ring finger. The target location may include one or more pixel coordinates in the image data.

At block 508, the processing device may superimpose, at the target location in the image data, a virtual representation of the three-dimensional model. In some embodiments, when the wearable ornamental article is a ring, for example, the ring may be superimposed at the target location on a particular phalange in between two adjacent phalanges and their respective knuckles. The three-dimensional model may include a photo-realistic augmented reality view of the ring, which may provide a lifelike and/or realistic perception of the user wearing the ring on their hand via a user interface of the computing device. As such, the customer may be provided an impression of what the ring looks like on their actual hand (e.g., which is being livestreamed via video from the camera of the computing device). The user interface may dynamically refresh, in real-time or near real-time, the view of the three-dimensional model superimposed at the target location based on the movement of the body part. For example, if the customer rotates their hand in a one hundred eighty degree manner (e.g., flips their hand over from a backside view of the hand to a palm-side view of the hand), the three-dimensional model may be rotated accordingly such that the appropriate portions of the wearable ornamental article are displayed in the user interface. That is, when the backside of the hand is within the view of the camera, a topside of the three-dimensional model including a stone and a portion of the setting may be presented in an augmented reality view superimposed on the image of the user's actual hand, and when the palm-side of the hand is within the view of the camera, a bottom side of the three-dimensional model including just the bottom portion of the setting may be presented in an augmented reality view superimposed on the image of the user's actual hand.

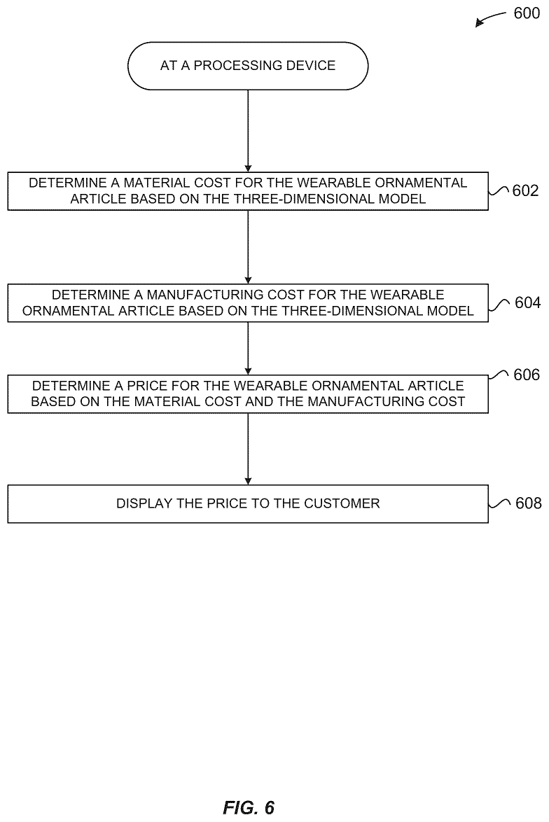

FIG. 6 illustrates an example of a method 600 for determining and displaying a price for a wearable ornamental article according to certain embodiments of this disclosure. The method 600 may be performed by processing logic that may include hardware (circuitry, dedicated logic, etc.), software, or a combination of both. The method 600 and/or each of their individual functions, subroutines, or operations may be performed by one or more processors of a computing device (e.g., any component (server 128, training engine 152, machine learning models 154, etc.) of cloud-based computing system 116, computing device 14, and/or computing device 12 of FIG. 1) implementing the method 600. The method 600 may be implemented as computer instructions stored on a memory device and executable by the one or more processors. In certain implementations, the method 600 may be performed by a single processing thread. Alternatively, the method 600 may be performed by two or more processing threads, each thread implementing one or more individual functions, routines, subroutines, or operations of the methods.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 602, the processing device may determine a material cost for the wearable ornamental article based on the three-dimensional model. The material cost may be based on a price per weight of the material. For example, the amount of the material may be measured in weight and the price per weight may be used to calculate the material cost.

At block 604, the processing device may determine a manufacturing cost for the wearable ornamental article based on the three-dimensional model. The manufacturing cost may be based on the materials being used, the duration of use of the manufacturing machine, the labor, and the like.

At block 606, the processing device may determine a price for the wearable ornamental article based at least one the material cost and the manufacturing cost. In some embodiments, the price may also be determined based on labor cost, tariff cost, shipping cost (e.g., standard, expedited, overnight, etc.), stone cost, etc.

At block 608, the processing device may display the price to the customer. The price may be displayed in real-time (e.g., less than 2 seconds) or near real-time (e.g., 2 to 10 seconds) on a user interface displayed on a computing device 12 of the customer. In some embodiments, the price may be presented concurrently with the augmented reality view of the wearable consumer article. In some embodiments, the price may dynamically change in real-time as one or more design parameters of the wearable ornamental article are changed via input from the customer, sales person, or the like.

In some embodiments, the processing device may receive an updated customer input indicating a design change for the wearable ornamental article. The processing device may generate, based on the design change, an updated three-dimensional model of the wearable ornamental article. The processing device may determine an updated material cost for the wearable ornamental article based on the updated three-dimensional model. The processing device may determine an updated manufacturing cost for the wearable ornamental article based on the updated three-dimensional model. The processing device may determine an updated price for the wearable ornamental article based on the updated material cost and the updated manufacturing cost. The processing device may display the updated price to the customer. For example, the updated price may be displayed, via a user interface of the computing device 12, concurrently with an updated augmented reality view of the updated three-dimensional model of the wearable ornamental article.

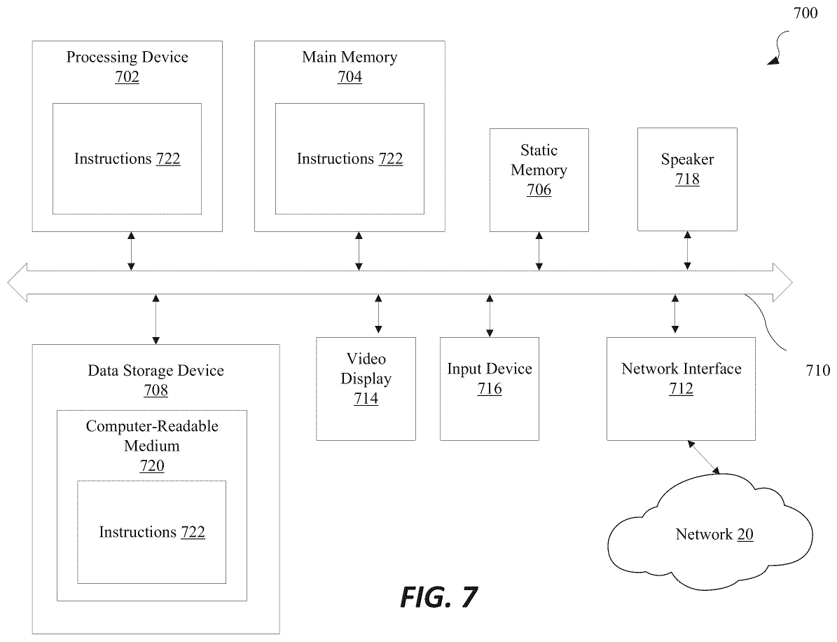

FIG. 7 illustrates an example computer system 700, which can perform any one or more of the methods described herein. In one example, computer system 700 may include one or more components that correspond to the computing device 12, computing device 14, one or more servers 128 of the cloud-based computing system 116, or one or more training engines 152 of the cloud-based computing system 116 of FIG. 1. The computer system 700 may be connected (e.g., networked) to other computer systems in a LAN, an intranet, an extranet, or the Internet. The computer system 700 may operate in the capacity of a server in a client-server network environment. The computer system 700 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 700 includes a processing device 702, a main memory 704 (e.g., read-only memory (ROM), solid state drive (SSD), flash memory, dynamic random access memory (DRAM) such as synchronous DRAM (SDRAM)), a static memory 706 (e.g., solid state drive (SSD), flash memory, static random access memory (SRAM)), and a data storage device 708, which communicate with each other via a bus 710.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute instructions for performing any of the operations and steps of any of the methods discussed herein.

The computer system 700 may further include a network interface device 712. The computer system 700 also may include a video display 714 (e.g., a liquid crystal display (LCD) or a cathode ray tube (CRT)), one or more input devices 716 (e.g., a keyboard and/or a mouse), and one or more speakers 718 (e.g., a speaker). In one illustrative example, the video display 714 and the input device(s) 716 may be combined into a single component or device (e.g., an LCD touch screen).

The data storage device 716 may include a computer-readable medium 720 on which the instructions 722 embodying any one or more of the methodologies or functions described herein are stored. The instructions 722 may also reside, completely or at least partially, within the main memory 704 and/or within the processing device 702 during execution thereof by the computer system 700. As such, the main memory 704 and the processing device 702 also constitute computer-readable media. The instructions 722 may further be transmitted or received over a network 20 via the network interface device 712.

While the computer-readable storage medium 720 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Clauses:

Clause 1. A method of using augmented reality for generating custom-designed wearable ornamental articles, the method comprising: receiving a set of customer inputs indicating design parameters for a wearable ornamental article: generating, based on the design parameters, a three-dimensional model of the wearable ornamental article: displaying an augmented reality view of the three-dimensional model positioned on the customer's body; and manufacturing the wearable ornamental article based on the three-dimensional model.

Clause 2. The method of any preceding clause, wherein displaying the augmented reality view of the three-dimensional model positioned on the customer's body further includes: receiving image data of a body part of the customer: determining, based on the image data, a position of a target feature on the body part: determining, based on the position of the target feature, a target location in the image data for the three-dimensional model: and superimposing, at the target location in the image data, a virtual representation of the three-dimensional model.

Clause 3. The method of any preceding clause, further comprising: determining a material cost for the wearable ornamental article based on the three-dimensional model; determining a manufacturing cost for the wearable ornamental article based on the three-dimensional model: determining a price for the wearable ornamental article based on the material cost and the manufacturing cost: and displaying the price to the customer.

Clause 4. The method of any preceding clause, further comprising: receiving an updated customer input indicating a design change for the wearable ornamental article; generating, based on the design change, an updated three-dimensional model of the wearable ornamental article: determining an updated material cost for the wearable ornamental article based on the updated three-dimensional model: determining an updated manufacturing cost for the wearable ornamental article based on the updated three-dimensional model; determining an updated price for the wearable ornamental article based on the updated material cost and the updated manufacturing cost: and displaying the updated price to the customer.

Clause 5. The method of any preceding clause, further comprising: comparing the three-dimensional model to a predetermined model: determining a metric indicating a design differential between the three-dimensional model and the predetermined model; determining that the metric is below a predetermined threshold: and responsively generating a warning signal.

Clause 6. The method of any preceding clause, wherein the set of customer inputs comprise at least one selected from the group consisting of image data, audio data, and hand-written notes.

Clause 7. The method of any preceding clause, wherein the wearable ornamental article includes a piece of jewelry.

Clause 8. A system of using augmented reality for generating custom-designed wearable ornamental articles, the system comprising: a user interface: a display: and a processing device configured to: receive, with the user interface, a set of customer inputs indicating design parameters for a wearable ornamental article: generate, based on the design parameters, a three-dimensional model of the wearable ornamental article: display, on the display, an augmented reality view of the three-dimensional model positioned on the customer's body: and manufacture the wearable ornamental article based on the three-dimensional model.

Clause 9. The system of any preceding clause, wherein the system further comprising one or more image sensors, and wherein, to display the augmented reality view of the three-dimensional model positioned on the customer's body, the processing device is further configured to: receive, from the one or more image sensors, image data of a body part of the customer: determine, based on the image data, a position of a target feature on the body part: determine, based on the position of the target feature, a target location in the image data for the three-dimensional model: and superimpose, at the target location in the image data, a virtual representation of the three-dimensional model.

Clause 10. The system of any preceding clause, wherein the processing device is further configured to: determine a material cost for the wearable ornamental article based on the three-dimensional model: determine a manufacturing cost for the wearable ornamental article based on the three-dimensional model: determine a price for the wearable ornamental article based on the material cost and the manufacturing cost: and display, on the display, the price to the customer.

Clause 11. The system of any preceding clause, wherein the processing device is further configured to: receive an updated customer input indicating a design change for the wearable ornamental article: generate, based on the design change, an updated three-dimensional model of the wearable ornamental article, determine an updated material cost for the wearable ornamental article based on the updated three-dimensional model; determine an updated manufacturing cost for the wearable ornamental article based on the updated three-dimensional model: determine an updated price for the wearable ornamental article based on the updated material cost and the updated manufacturing cost: and display, on the display, the updated price to the customer

Clause 12. The system of any preceding clause, wherein the processing device is further configured to: compare the three-dimensional model to a predetermined model; determine a metric indicating a design differential between the three-dimensional model and the predetermined model: determine that the metric is below a predetermined threshold: and responsively generate a warning signal.

Clause 13. The system of any preceding clause, wherein the set of customer inputs comprise at least one selected from the group consisting of image data, audio data, and hand-written notes.

Clause 14. The system of any preceding clause, wherein the wearable ornamental article includes a piece of jewelry.

Clause 15. A non-transitory computer-readable medium storing instructions that, when executed, cause a processing device to: receive a set of customer inputs indicating design parameters for a wearable ornamental article: generate, based on the design parameters, a three-dimensional model of the wearable ornamental article: display an augmented reality view of the three-dimensional model positioned on the customer's body; and manufacture the wearable ornamental article based on the three-dimensional model.

Clause 16. The non-transitory computer-readable medium of any preceding clause, wherein the instructions further cause the processing device to: determine a material cost for the wearable ornamental article based on the three-dimensional model: determine a manufacturing cost for the wearable ornamental article based on the three-dimensional model: determine a price for the wearable ornamental article based on the material cost and the manufacturing cost: and display the price to the customer.

Clause 17. The non-transitory computer-readable medium of any preceding clause, wherein the instructions further cause the processing device to: receive an updated customer input indicating a design change for the wearable ornamental article: generate, based on the design change, an updated three-dimensional model of the wearable ornamental article: determine an updated material cost for the wearable ornamental article based on the updated three-dimensional model: determine an updated manufacturing cost for the wearable ornamental article based on the updated three-dimensional model: determine an updated price for the wearable ornamental article based on the updated material cost and the updated manufacturing cost: and display the updated price to the customer.

Clause 18. The non-transitory computer-readable medium of any preceding clause, wherein the instructions further cause the processing device to: compare the three-dimensional model to a predetermined model: determine a metric indicating a design differential between the three-dimensional model and the predetermined model: determine that the metric is below a predetermined threshold: and responsively generate a warning signal.

Clause 19. The non-transitory computer-readable medium of any preceding clause, wherein the set of customer inputs comprise at least one selected from the group consisting of image data, audio data, and hand-written notes.

Clause 20. The non-transitory computer-readable medium of any preceding clause, wherein the wearable ornamental article includes a piece of jewelry.

Clause 21. The non-transitory computer-readable medium of any preceding clause, wherein displaying the augmented reality view of the three-dimensional model positioned on the customer's body further includes: receiving image data of a body part of the customer: determining, based on the image data, a position of a target feature on the body part: determining, based on the position of the target feature, a target location in the image data for the three-dimensional model: and superimposing, at the target location in the image data, a virtual representation of the three-dimensional model.

Clause 22. An apparatus comprising: a memory device storing instructions: a processing device communicatively coupled to the memory device, wherein the processing device executes the instructions to: receive a set of customer inputs indicating design parameters for a wearable ornamental article: generate, based on the design parameters, a three-dimensional model of the wearable ornamental article: display an augmented reality view of the three-dimensional model positioned on the customer's body: and manufacture the wearable ornamental article based on the three-dimensional model.

Clause 23. The apparatus of any preceding clause, wherein displaying the augmented reality view of the three-dimensional model positioned on the customer's body further includes: receiving image data of a body part of the customer: determining, based on the image data, a position of a target feature on the body part: determining, based on the position of the target feature, a target location in the image data for the three-dimensional model: and superimposing, at the target location in the image data, a virtual representation of the three-dimensional model.

Clause 24. The apparatus of any preceding clause, wherein the instructions further cause the processing device to: determine a material cost for the wearable ornamental article based on the three-dimensional model: determine a manufacturing cost for the wearable ornamental article based on the three-dimensional model: determine a price for the wearable ornamental article based on the material cost and the manufacturing cost: and display the price to the customer.

Clause 25. The apparatus of any preceding clause, wherein the instructions further cause the processing device to: receive an updated customer input indicating a design change for the wearable ornamental article: generate, based on the design change, an updated three-dimensional model of the wearable ornamental article: determine an updated material cost for the wearable ornamental article based on the updated three-dimensional model: determine an updated manufacturing cost for the wearable ornamental article based on the updated three-dimensional model: determine an updated price for the wearable ornamental article based on the updated material cost and the updated manufacturing cost: and display the updated price to the customer.

Clause 26. The apparatus of any preceding clause, wherein the instructions further cause the processing device to: compare the three-dimensional model to a predetermined model: determine a metric indicating a design differential between the three-dimensional model and the predetermined model: determine that the metric is below a predetermined threshold: and responsively generate a warning signal.

Clause 27. The apparatus of any preceding clause, wherein the set of customer inputs comprise at least one selected from the group consisting of image data, audio data, and hand-written notes.

Clause 28. The apparatus of any preceding clause, wherein the wearable ornamental article includes a piece of jewelry.

Clause 29. The apparatus of any preceding clause, wherein the instructions further cause the processing device to generate, using the initial data, one or more alternative three-dimensional models based on one or more constraints, wherein the initial data comprises the three-dimensional model, the design parameters, or both.

Clause 30. The apparatus of any preceding clause, wherein the instructions further cause the processing device to: present a virtual showcase include one or more three-dimensional models of one or more wearable ornamental articles; and concurrently present, in a user interface, one or more images comprising one or more augmented reality views of the one or more three-dimensional models on the customer's body.

1. A method of using augmented reality for generating custom-designed wearable ornamental articles, the method comprising:
receiving a set of customer inputs indicating design parameters for a wearable ornamental article;
generating, based on the design parameters, a three-dimensional model of the wearable ornamental article;
displaying an augmented reality view of the three-dimensional model positioned on the customer's body; and
manufacturing the wearable ornamental article based on the three-dimensional model.

2. The method of claim 1, wherein displaying the augmented reality view of the three-dimensional model positioned on the customer's body further includes:
receiving image data of a body part of the customer;
determining, based on the image data, a position of a target feature on the body part;
determining, based on the position of the target feature, a target location in the image data for the three-dimensional model; and
superimposing, at the target location in the image data, a virtual representation of the three-dimensional model.

3. The method of claim 1, further comprising:
determining a material cost for the wearable ornamental article based on the three-dimensional model;
determining a manufacturing cost for the wearable ornamental article based on the three-dimensional model;
determining a price for the wearable ornamental article based on the material cost and the manufacturing cost; and
displaying the price to the customer.

4. The method of claim 3, further comprising:
receiving an updated customer input indicating a design change for the wearable ornamental article;
generating, based on the design change, an updated three-dimensional model of the wearable ornamental article;
determining an updated material cost for the wearable ornamental article based on the updated three-dimensional model;
determining an updated manufacturing cost for the wearable ornamental article based on the updated three-dimensional model;
determining an updated price for the wearable ornamental article based on the updated material cost and the updated manufacturing cost; and
displaying the updated price to the customer.

5. The method of claim 1, further comprising:
comparing the three-dimensional model to a predetermined model;
determining a metric indicating a design differential between the three-dimensional model and the predetermined model;
determining that the metric is below a predetermined threshold; and
responsively generating a warning signal.

6. The method of claim 1, wherein the set of customer inputs comprise at least one selected from the group consisting of image data, audio data, and hand-written notes.

7. The method of claim 1, wherein the wearable ornamental article includes a piece of jewelry.

8. A system of using augmented reality for generating custom-designed wearable ornamental articles, the system comprising:
a user interface;
a display; and
a processing device configured to:
receive, with the user interface, a set of customer inputs indicating design parameters for a wearable ornamental article;
generate, based on the design parameters, a three-dimensional model of the wearable ornamental article;
display, on the display, an augmented reality view of the three-dimensional model positioned on the customer's body; and
manufacture the wearable ornamental article based on the three-dimensional model.

9. The system of claim 8, wherein the system further comprising one or more image sensors, and wherein, to display the augmented reality view of the three-dimensional model positioned on the customer's body, the processing device is further configured to:
receive, from the one or more image sensors, image data of a body part of the customer;
determine, based on the image data, a position of a target feature on the body part;
determine, based on the position of the target feature, a target location in the image data for the three-dimensional model; and
superimpose, at the target location in the image data, a virtual representation of the three-dimensional model.

10. The system of claim 8, wherein the processing device is further configured to:
determine a material cost for the wearable ornamental article based on the three-dimensional model;
determine a manufacturing cost for the wearable ornamental article based on the three-dimensional model;
determine a price for the wearable ornamental article based on the material cost and the manufacturing cost; and
display, on the display, the price to the customer.

11. The system of claim 10, wherein the processing device is further configured to:
receive an updated customer input indicating a design change for the wearable ornamental article,
generate, based on the design change, an updated three-dimensional model of the wearable ornamental article;
determine an updated material cost for the wearable ornamental article based on the updated three-dimensional model;
determine an updated manufacturing cost for the wearable ornamental article based on the updated three-dimensional model;
determine an updated price for the wearable ornamental article based on the updated material cost and the updated manufacturing cost; and
display, on the display, the updated price to the customer.

12. The system of claim 8, wherein the processing device is further configured to:
compare the three-dimensional model to a predetermined model;
determine a metric indicating a design differential between the three-dimensional model and the predetermined model;
determine that the metric is below a predetermined threshold; and
responsively generate a warning signal.

13. The system of claim 8, wherein the set of customer inputs comprise at least one selected from the group consisting of image data, audio data, and hand-written notes.

14. The system of claim 8, wherein the wearable ornamental article includes a piece of jewelry.

15. A non-transitory computer-readable medium storing instructions that, when executed, cause a processing device to:
receive a set of customer inputs indicating design parameters for a wearable ornamental article;
generate, based on the design parameters, a three-dimensional model of the wearable ornamental article;
display an augmented reality view of the three-dimensional model positioned on the customer's body; and
manufacture the wearable ornamental article based on the three-dimensional model.

16. The non-transitory computer-readable medium of claim 15, wherein the instructions further cause the processing device to:
determine a material cost for the wearable ornamental article based on the three-dimensional model;
determine a manufacturing cost for the wearable ornamental article based on the three-dimensional model;
determine a price for the wearable ornamental article based on the material cost and the manufacturing cost; and
display the price to the customer.

17. The non-transitory computer-readable medium of claim 16, wherein the instructions further cause the processing device to:
receive an updated customer input indicating a design change for the wearable ornamental article;
generate, based on the design change, an updated three-dimensional model of the wearable ornamental article;
determine an updated material cost for the wearable ornamental article based on the updated three-dimensional model;
determine an updated manufacturing cost for the wearable ornamental article based on the updated three-dimensional model;
determine an updated price for the wearable ornamental article based on the updated material cost and the updated manufacturing cost; and
display the updated price to the customer.

18. The non-transitory computer-readable medium of claim 0, wherein the instructions further cause the processing device to:
compare the three-dimensional model to a predetermined model;
determine a metric indicating a design differential between the three-dimensional model and the predetermined model;
determine that the metric is below a predetermined threshold; and
responsively generate a warning signal.

19. The non-transitory computer-readable medium of claim 15, wherein the set of customer inputs comprise at least one selected from the group consisting of image data, audio data, and hand-written notes.

20. The non-transitory computer-readable medium of claim 15, wherein the wearable ornamental article includes a piece of jewelry.

21. The non-transitory computer-readable medium of claim 15, wherein displaying the augmented reality view of the three-dimensional model positioned on the customer's body further includes:
receiving image data of a body part of the customer;
determining, based on the image data, a position of a target feature on the body part;
determining, based on the position of the target feature, a target location in the image data for the three-dimensional model; and
superimposing, at the target location in the image data, a virtual representation of the three-dimensional model.

22. An apparatus comprising:
a memory device storing instructions;
a processing device communicatively coupled to the memory device, wherein the processing device executes the instructions to:
receive a set of customer inputs indicating design parameters for a wearable ornamental article;
generate, based on the design parameters, a three-dimensional model of the wearable ornamental article;
display an augmented reality view of the three-dimensional model positioned on the customer's body; and
manufacture the wearable ornamental article based on the three-dimensional model.

23. The apparatus of claim 22, wherein displaying the augmented reality view of the three-dimensional model positioned on the customer's body further includes:
receiving image data of a body part of the customer;
determining, based on the image data, a position of a target feature on the body part;
determining, based on the position of the target feature, a target location in the image data for the three-dimensional model; and
superimposing, at the target location in the image data, a virtual representation of the three-dimensional model.

24. The apparatus of claim 22, wherein the instructions further cause the processing device to:
determine a material cost for the wearable ornamental article based on the three-dimensional model;
determine a manufacturing cost for the wearable ornamental article based on the three-dimensional model;
determine a price for the wearable ornamental article based on the material cost and the manufacturing cost; and
display the price to the customer.

25. The apparatus of claim 22, wherein the instructions further cause the processing device to:
receive an updated customer input indicating a design change for the wearable ornamental article;
generate, based on the design change, an updated three-dimensional model of the wearable ornamental article;
determine an updated material cost for the wearable ornamental article based on the updated three-dimensional model;
determine an updated manufacturing cost for the wearable ornamental article based on the updated three-dimensional model;
determine an updated price for the wearable ornamental article based on the updated material cost and the updated manufacturing cost; and
display the updated price to the customer.

26. The apparatus of claim 22, wherein the instructions further cause the processing device to:
compare the three-dimensional model to a predetermined model;
determine a metric indicating a design differential between the three-dimensional model and the predetermined model;
determine that the metric is below a predetermined threshold; and
responsively generate a warning signal.

27. The apparatus of claim 22, wherein the set of customer inputs comprise at least one selected from the group consisting of image data, audio data, and hand-written notes.

28. The apparatus of claim 22, wherein the wearable ornamental article includes a piece of jewelry.

29. The apparatus of claim 22, wherein the instructions further cause the processing device to generate, using the initial data, one or more alternative three-dimensional models based on one or more constraints, wherein the initial data comprises the three-dimensional model, the design parameters, or both.

30. The apparatus of claim 22, wherein the instructions further cause the processing device to:
present a virtual showcase include one or more three-dimensional models of one or more wearable ornamental articles; and
concurrently present, in a user interface, one or more images comprising one or more augmented reality views of the one or more three-dimensional models on the customer's body.
